(19) United States
(12) Patent Application Publication
(10) Pub. No.: US 2013/0273228 A1
(43) Pub. Date: Oct. 17, 2013

(54) BEER FLAVORED BEVERAGE CONTAINING NON-POLYMER CATECHINS

(71) Applicants: Naoki Hosoya, Kamisu-shi (JP); Masaki Iwasaki, Funabashi-shi (JP)

(72) Inventors: Naoki Hosoya, Kamisu-shi (JP); Masaki Iwasaki, Funabashi-shi (JP)

(73) Assignee: KAO CORPORATION, Tokyo (JP)

(21) Appl. No.: 13/977,234

(22) PCT Filed: Dec. 28, 2011
(86) PCT No.: PCT/JP11/80472

§ 371 Date: Jun. 28, 2013

(30) Foreign Application Priority Data
Dec. 28, 2010 (JP) 2010-292940

(51) Int. Cl. A23L 2/52; C12G 3/00

(52) U.S. Cl. CPC A23L 2/52; C12G 3/00
USPC 426/592; 426/590

(57) ABSTRACT

Provided is a beer flavored beverage containing the non-polymer catechins at a high concentration but having bitterness and refreshing finish suitable for the beverage to have a beer taste and suppressed astringency. The beer flavored beverage containing the non-polymer catechins according to the present invention comprises the following components (A), (B), (C), and (D): (A) from 0.03 to 0.4 mass % of the non-polymer catechins; (B) a malt extract; (C) from 0.0005 to 0.06 mass % of potassium; and (D) from 0 to 2.8 mass % of an alcohol, in which: a mass ratio ((C)/(A)) between the component (A) and the component (C) ranges from 0.003 to 1.2; and a quantitative ratio between the component (A) and the component (D) satisfies a relationship represented by the following expression (1):0≦(d)≦3−6.5×(a) (1) (in the expression (1), (a) and (d) represent a mass fraction (mass %) of the component (A) and a mass fraction (mass %) of the component (D), respectively).

### FIELD OF THE INVENTION

The present invention relates to a beer flavored beverage containing the non-polymer catechins.

### BACKGROUND OF THE INVENTION

Alcohol beverages containing catechins have been known, for example, a beer produced by fermentation using malt, hops, and water as main raw materials and supplemented with from 0.1 to 0.2% of catechin tannin (Patent Document 1) and a tea-based alcohol beverage obtained by adding from 15 to 60 vol % of ethanol to a tea-based extract solution having a concentration from 1.5 to 20 times as high as that for drinking and diluting the resulting mixture with water (Patent Document 2).

In addition, a beer containing a white tea extract obtained from white tea which is made from immature tea leaves has been proposed (Patent Document 3). The white tea taste and flavor is compatible with the beer taste and flavor, and hence the beer? is considered to have an ability to suppress astringency originating from tea.

### CITATION LIST

### Patent Document

[Patent Document 1] JP-A-2001-231537
[Patent Document 2] JP-A-2002-209519
[Patent Document 3] JP-A-2009-531046

### SUMMARY OF THE INVENTION

The present invention provides a beer flavored beverage containing the non-polymer catechins, comprising the following components (A), (B), (C), and (D):

(A) from 0.03 to 0.4 mass % of the non-polymer catechins;

(B) a malt extract;

(C) from 0.0005 to 0.06 mass % of potassium; and

(D) from 0 to 2.8 mass % of an alcohol,

wherein the mass ratio ((C)/(A)) between the component (A) and the component (C) ranges from 0.003 to 1.2; and the quantitative ratio between the component (A) and the component (D) satisfies a relationship represented by the following expression (1):

0≦(d)≦3−6.5×(a) (1)

wherein in the expression (1), (a) and (d) represent amass fraction (mass %) of the component (A) and a mass fraction (mass %) of the component (D), respectively.

### DETAILED DESCRIPTION OF THE INVENTION

Alcohol beverages containing catechins produced by the above-mentioned conventional technologies are generally prepared by blending a tea extract and an alcohol. However, in some cases, astringency and raw smell originating from the tea extract are sensed. In particular, the astringency is incompatible with beer, and the taste and flavor of beer are impaired in some cases.

In addition, the beer described in Patent Document 3 contains the non-polymer catechins, but the concentration of the non-polymer catechins is extremely low. The inventors of the present invention found a problem in that, when the concentration of the non-polymer catechins in beer is increased, the astringency is enhanced which impairs the taste and flavor of the beer.

Therefore, the inventors of the present invention have made various studies to improve the compatibility between the non-polymer catechins and beer taste and flavor. As a result, the inventors found that the astringency is suppressed by blending a malt extract with the non-polymer catechins, but discovered a new problem in that the refreshing finish, i.e. crisp taste, peculiar to beer is not sensed.

The present invention provides a beer flavored beverage which comprises the non-polymer catechins at a high concentration, the beverage having suitable bitterness and refreshing finish suitable for the taste of a beer beverage, and also has suppressed astringency.

The inventors of the present invention have made various studies to develop a beer flavored beverage containing the non-polymer catechins at a high concentration. As a result, the inventors found that, in a beer flavored beverage, astringency is enhanced by an increased concentration of the non-polymer catechins. In addition, the inventors found that an enhancement of astringency is caused by alcohol because the astringency is suppressed when a malt extract alone is added to an alcohol-free system. Further, the inventors found that deterioration of the refreshing finish peculiar to beer is caused by the content of potassium. In addition, the inventors found that in a beverage blended with malt extract, a beer flavored beverage containing the non-polymer catechins at a high concentration, but having bitterness and refreshing finish suitable as a beverage having a beer taste and suppressed astringency, is obtained by controlling the content of the non-polymer catechins and the content of potassium, as well as the mass ratio there between to specific ranges and adjusting the quantitative ratio between the non-polymer catechins and alcohol so as to satisfy a certain relationship. In addition, the studies show satisfactory bitterness of a beer flavored beverage of the present invention can be developed without using hops.

According to the present invention, a beer flavored beverage which contains the non-polymer catechins at a high concentration but has bitterness and refreshing finish which is suitable as a beverage having a beer taste and flavor and has suppressed astringency which is incompatible with the beer taste and flavor can be provided.

The beer flavored beverage of the present invention contains the non-polymer catechins (A) at a concentration as high as from 0.03 to 0.4 mass %. From the viewpoint of imparting adequate bitterness, the lower limit is preferably 0.04 mass %, more preferably 0.05 mass %, more preferably 0.06 mass %, more preferably 0.08 mass %, even more preferably 0.1 mass %, while the upper limit is preferably 0.32 mass %, more preferably 0.3 mass %, more preferably 0.28 mass %, more preferably 0.25 mass %, more preferably 0.22 mass %, even more preferably 0.2 mass %. The content of the non-polymer catechins (A) ranges preferably from 0.04 to 0.32 mass %, more preferably from 0.05 to 0.3 mass %, more preferably from 0.05 to 0.28 mass %, more preferably from 0.05 to 0.25 mass %, more preferably from 0.06 to 0.25 mass %, more preferably from 0.08 to 0.2 mass %, and even more preferably from 0.1 to 0.2 mass %. The term “non-polymer catechins (A)” as used herein is a collective term for non-epi-form catechins such as catechin, gallocatechin, catechingallate, andgallocatechin gallate and epi-form catechins such as epicatechin, epigallocatechin, epicatechin gallate, and epigallocatechin gallate, and the concentration of the non-polymer catechins is defined based on the total amount of the above-mentioned eight compounds. It should be noted that the concentration of the non-polymer catechins is measured in accordance with a method described in Examples below.

In addition, from the viewpoints of suppressing astringency and imparting adequate bitterness in the beer flavored beverage of the present invention, the mass ratio ((A)/(E)) between the non-polymer catechins (A) and tannin (E) ranges preferably from 0.8 to 1.2, more preferably from 0.85 to 1.1, more preferably from 0.9 to 1.05, and even more preferably from 0.9 to 0.99. It should be noted that the concentration of tannin is measured in accordance with a method described in Examples below.

The beer flavored beverage of the present invention contains the malt extract (B), and the malt extract (B) is used for imparting a beer-like taste and flavor. The term “malt extract” as used herein refers to a non-fermented or fermented solution obtained by extraction of malt with warm water. The term “non-fermented malt extract” as used herein refers to an extract obtained by adding warm water to a product obtained by adding water to a barley, such as Hordeum vulgare to germinate, and drying the resultant solution (also referred to as malt), and then extracting the resultant, or an extract obtained by adding warm water to malt, decomposing (saccharifying) starch by the action of an enzyme contained in the malt, and then extracting the resultant. In addition, the term “fermented malt extract” refers to an extract obtained by inoculating yeast after the above-mentioned saccharification, fermenting the resultant, and then performing extraction. In the present invention, from the viewpoint of production efficiency, in the case of an alcohol-containing beverage, the fermented malt extract is preferably used, and in the case of anon-alcoholic beverage, the non-fermented malt extract is preferably used. However, from the viewpoint of reducing astringency, in both the cases, the non-fermented malt extract is preferably used. The term “non-alcoholic” as used herein refers to a concept comprising not only an alcohol content of 0 mass %, but also an alcohol content which does not fall within the alcohol content of an alcoholic beverage defined by regulation (such as, the Liquor Tax Act in Japan).

From the viewpoints of production efficiency and imparting adequate bitterness, the malt extract (B) has preferably a Brix degree (20° C.) of from 5 to 30, more preferably a Brix degree of from 10 to 20. In addition, the content of potassium in the malt extract ranges preferably from 0.05 to 0.3 mass %, more preferably from 0.08 to 0.2 mass % from the viewpoint of production efficiency. The beer flavored beverage of the present invention contains the malt extract (B) having a Brix degree in the above-mentioned ranges at a concentration of preferably from 0.2 to 30 mass %, more preferably from 1 to 20 mass %, more preferably from 2 to 20 mass %, even more preferably from 2 to 15 mass % from the viewpoints of production efficiency and imparting adequate bitterness.

The beer flavored beverage of the present invention contains potassium (C) at a concentration of from 0.0005 to 0.06 mass %, and from the viewpoints of suppressing astringency and improving refreshing finish, the concentration ranges preferably from 0.0006 to 0.052 mass %, more preferably from 0.001 to 0.05 mass %, more preferably from 0.002 to 0.04 mass %, more preferably from 0.004 to 0.03 mass %, more preferably from 0.004 to 0.02 mass %, even more preferably from 0.0059 to 0.02 mass %. It should be noted that the potassium (C) includes one derived not only from the malt extract (B) but also from a catechin preparation which is a supply source of the non-polymer catechins (A), but is derived mainly from the malt extract (B).

In addition, in the beer flavored beverage, the mass ratio ((C)/(A)) between the non-polymer catechins (A) and the potassium (C) ranges from 0.003 to 1.2. From the viewpoints of suppressing astringency, imparting adequate bitterness, and improving refreshing finish, the lower limit is preferably 0.005 mass %, more preferably 0.01 mass %, more preferably 0.02 mass %, even more preferably 0.03 mass %, while the upper limit is preferably 1 mass %, more preferably 0.7 mass %, more preferably 0.5 mass %, more preferably 0.4 mass %, more preferably 0.38 mass %, more preferably 0.26 mass %, more preferably 0.2 mass %, more preferably 0.15 mass %, more preferably 0.12 mass %, even more preferably 0.08 mass %. The mass ratio ((C)/(A)) ranges preferably from 0.005 to 1, more preferably from 0.01 to 0.7, more preferably from 0.02 to 0.5, more preferably from 0.02 to 0.38, more preferably from 0.03 to 0.26, more preferably from 0.03 to 0.2, more preferably from 0.03 to 0.15, more preferably from 0.03 to 0.12, even more preferably from 0.03 to 0.08.

The beer flavored beverage of the present invention contains (D) from 0 to 2.8 mass % of an alcohol, and at the same time, the quantitative ratiobetween the component (A) and the alcohol satisfies the following expression:

0≦(d)≦3−6.5×(a) (1)

in the expression (1), (a) and (d) represent amass fraction (mass %) of the non-polymer catechins (A) and a mass fraction (mass %) of the alcohol (D), respectively.

The content of the alcohol (D) in the beer flavored beverage of the present invention ranges from 0 to 2.8 mass %, preferably from 0 to 2.74 mass %, more preferably from 0 to 2.61 mass %, more preferably from 0 to 2.48 mass %, more preferably from 0 to 2 mass %, and is even more preferably a non-alcohol, from the viewpoints of suppressing astringency and imparting adequate bitterness. More specifically, in the case of an alcohol-containing beverage, the content of the alcohol (D) in the beverage ranges preferably from 1 to 2.74 mass %, more preferably from 1 to 2.61 mass %, more preferably from 1 to 2.48 mass %, even more preferably from 1 to 2 mass %. On the other hand, in the case of a non-alcoholic beverage, the content of the alcohol (D) in the beverage ranges preferably from 0 to less than 1 mass %. It should be noted that the term “alcohol” as used herein refers to ethanol.

The beer flavored beverage of the present invention may contain carbon dioxide gas (F). This can suppress astringency and can enhance the beer taste and flavor.

The carbon dioxide gas (F) to be injected may be appropriately selected, and from the viewpoints of suppressing astringency and enhancing the beer taste and flavor, the gas volume ratio ranges preferably from 0.5 to 4, more preferably from 1 to 3.5, even more preferably from 2 to 3. The term “gas volume ratio (gas volume)” as used herein refers to the ratio of the volume at 20° C. of carbon dioxide gas dissolved in a beverage to the volume of the beverage.

Further, the beer flavored beverage of the present invention may contain one or a combination of two or more additives such as sweeteners, acidulants, dietary fibers, vitamins, minerals, antioxidants, various esters, colorants, emulsifiers, preservatives, seasoning, vegetable extracts, floral nectar essenses, and quality stabilizers. It should be noted that the content of the additive may be appropriately selected in such a range that the object of the present invention is not impaired.

The beer flavored beverage of the present invention has a pH (20° C.) of preferably from 2 to 5, more preferably from 2.5 to 4.5, even more preferably from 3 to 4 from the viewpoints of the taste and flavor and the stability of the non-polymer catechins.

The beer flavored beverage of the present invention has a Brix degree (20° C.) of preferably from 0.1 to 10, more preferably from 0.3 to 7, even more preferably from 0.5 to 5 from the viewpoint of taste and flavor. It should be noted that the measurement of the Brix degree used herein is carried out in accordance with a method described in Examples below.

As a container which can be used for the beer flavored beverage of the present invention, for example, there are provided, normal packaging containers such as a molded container mainly made of polyethylene terephthalate (so-called PET bottle), a metallic can, or a bottle.

Such beer flavored beverage can be produced by a post-mixing method comprising: blending at least one selected from a catechin preparation and a purified catechin preparation, the malt extract (B), and an alcohol and an additive as required so that the concentration of the non-polymer catechins (A), the concentration of the potassium (C), the mass ratio there between, and the quantitative ratio between the non-polymer catechins (A) and the alcohol (D) fall within the above-mentioned ranges ; injecting the resultant mixture into a container such as a PET bottle; and filling carbonated water therein. In addition, after filling of the mixture in the container, heat-sterilization may be carried out under a sterilization condition defined by the applicable regulation (such as the Food Sanitation Act, in Japan) to sterilize the contents.

Examples of the “catechin preparation” to be used for production of the beer flavored beverage of the present invention include an extract solution which is obtained from tea leaves selected from unfermented tea, semi-fermented tea and fermented tea with hot water or a water-soluble organic solvent by kneader extraction, column extraction and the like, and which is not subjected to a concentration or purification procedure, or a concentration obtained by removing part of the solvent from the extract solution to increase the concentration of the non-polymer catechins. The catechin preparation may have various forms such as solid, aqueous solution, and slurry forms. A commercially available product may be used as the catechin preparation, and examples thereof include “POLYPHENON” manufactured by Mitsui Norin Co., Ltd., “TEAFURAN” manufactured by ITO EN, LTD., “SUNPHENON” manufactured by Taiyo Kagaku Co., Ltd and the like.

The tea leaves to be used for extraction are not piliferous or immature tea leaves but are preferably matured tea leaves which are fully opened.

In addition, examples of the purified catechin preparation include one obtained by any one of the following methods (i) to (iv) or by a combination of two or more thereof.
(i) A method involving suspending a catechin preparation in water, a water-soluble organic solvent (such as ethanol), or a mixture of water and the water-soluble organic solvent (hereinafter, referred to as “organic solvent aqueous solution”), removing the resultant precipitates, and distilling the solvent off (for example, JP-A-2004-147508 and JP-A-2004-149416).
(ii) A method involving bringing a catechin preparation into contact with at least one adsorbent selected from activated carbon, acid clay, and activated clay (for example, JP-A-2007-282568).
(iii) A method involving adsorbing a catechin preparation to a synthetic adsorbent and bringing the synthetic adsorbent into contact with an organic solvent aqueous solution to desorb the non-polymer catechins (for example, JP-A-2006-160656).
(iv) A method involving adsorbing a catechin preparation to a synthetic adsorbent, bringing the synthetic adsorbent into contact with an organic solvent aqueous solution or a basic aqueous solution (such as an aqueous sodium hydroxide solution) to desorb the non-polymer catechins, and bringing the resultant desorbed solution into contact with activated carbon (for example, JP-A-2008-079609).

In the above-mentioned methods (i) to (iv), the catechin preparation maybe used after a tannase treatment. The term “tannase treatment” as used herein refers to a procedure for bringing the catechin preparation into contact with an enzyme having a tannase activity. The treatment can adjust the ratio of gallate forms in the non-polymer catechins. It should be noted that as a specific operation method for the tannase treatment, a known method may be employed, and examples thereof include a method described in JP-A-2004-321105.

From the viewpoints of suppressing astringency and imparting adequate bitterness, of those, the catechin preparation is preferably a purified catechin preparation, and the purified catechin preparation having a mass ratio ((A)/(E)) within the above-mentioned range is more preferably used. In addition, the purity of the component (A), based on the solid content, of the catechin preparation ranges preferably from 25 to 90 mass %, more preferably from 30 to 80 mass %, more preferably from 40 to 70 mass %, even more preferably from 50 to 65 mass % from the viewpoints of suppressing astringency and imparting adequate bitterness.

A suitable embodiment of the present invention is as follows.
(1) A beer flavored beverage containing the non-polymer catechins, comprising the following components (A), (B), (C), and (D):

(A) from 0.03 to 0.4 mass % of the non-polymer catechins;

(B) a malt extract;

(C) from 0.0005 to 0.06 mass % of potassium; and

(D) from 0 to 2.8 mass % of an alcohol,

wherein, a mass ratio ((C)/(A)) between the component (A) and the component (C) ranges from 0.003 to 1.2; and a quantitative ratio between the component (A) and the component (D) satisfies a relationship represented by the following expression (1):

0≦(d)≦3−6.5×(a) (1)

wherein in the expression (1), (a) and (d) represent amass fraction (mass %) of the component (A) and a mass fraction (mass %) of the component (D), respectively.
(2) The beverage according to the above-mentioned item (1), in which the content of the non-polymer catechins (A) ranges preferably from 0.04 to 0.32 mass %, more preferably from 0.05 to 0.3 mass %, more preferably from 0.05 to 0.28 mass %, more preferably from 0.05 to 0.25 mass %, more preferably from 0.06 to 0.25 mass %, more preferably from 0.08 to 0.2 mass %, even more preferably from 0.1 to 0.2 mass %.
(3) The beverage according to the above-mentioned item (1) or (2), in which the content of the potassium (C) ranges preferably from 0.0006 to 0.052 mass %, more preferably from 0.001 to 0.05 mass %, more preferably from 0.002 to 0.04 mass %, more preferably from 0.004 to 0.03 mass %, more preferably from 0.004 to 0.02 mass %, and even more preferably from 0.0059 to 0.02 mass %.
(4) The beverage according to any one of the above-mentioned items (1) to (3), in which the mass ratio ((C)/(A)) ranges preferably from 0.005 to 1, more preferably from 0.01 to 0.7, more preferably from 0.02 to 0.5, more preferably from 0.02 to 0.38, more preferably from 0.03 to 0.26, more preferably from 0.03 to 0.2, more preferably from 0.03 to 0.15, more preferably from 0.03 to 0.12, even more preferably from 0.03 to 0.08.
(5) The beverage according to any one of the above-mentioned items (1) to (4), in which the malt extract (B) has a Brix degree of preferably from 5 to 30, more preferably from 10 to 20.
(6) The beverage according to the above-mentioned item (5), in which the content of the malt extract (B) ranges preferably from 0.2 to 30 mass %, more preferably from 1 to 20 mass %, more preferably from 2 to 20 mass %, even more preferably from 2 to 15 mass %.
(7) The beverage according to any one of the above-mentioned items (1) to (6) , in which the content of the potassium in the malt extract (B) ranges preferably from 0.05 to 0.3 mass%, more preferably from 0.08 to 0.2 mass %.
(8) The beverage according to any one of the above-mentioned items (1) to (7), in which the content of the alcohol (D) ranges preferably from 0 to 2.74 mass %, more preferably from 0 to 2.61 mass %, more preferably from 0 to 2.48 mass %, even more preferably from 0 to 2 mass %.
(9) The beverage according to any one of the above-mentioned items (1) to (8), further comprising carbon dioxide gas (F).
(10) The beverage according to the above-mentioned item (9), in which the content of the carbon dioxide gas (F) ranges preferably from 0.5 to 4, more preferably 1 to 3.5, even more preferably from 2 to 3 in terms of the gas volume ratio.
(11) The beverage according to any one of the above-mentioned items (1) to (10), in which the malt extract (B) comprises a non-fermented malt extract.
(12) The beverage according to any one of the above-mentioned items (1) to (11), in which the beverage comprises a non-alcohol beverage. (13) The beverage according to the above-mentioned item (12), in which the content of the alcohol (D) ranges from 0 to less than 1 mass %.
(14) The beverage according to any one of the above-mentioned items (1) to (11), in which the beverage comprises an alcohol beverage, and the content of the alcohol (D) in the beverage ranges preferably from 1 to 2.74 mass %, more preferably from 1 to 2.61 mass %, more preferably from 1 to 2.48 mass %, even more preferably from 1 to 2 mass %.
(15) The beverage according to any one of the above-mentioned items (1) to (14), in which the beverage has a pH of preferably from 2 to 5, more preferably from 2.5 to 4.5, even more preferably from 3 to 4.
(16) The beverage according to any one of the above-mentioned items (1) to (15), in which the beverage has a Brix degree of preferably from 0.1 to 10, more preferably from 0.3 to 7, even more preferably from 0.5 to 5.
(17) The beverage according to any one of the above-mentioned items (1) to (16), in which a mass ratio ((A) / (E)) between the component (A) and tannin (E) ranges preferably from 0.8 to 1.2, more preferably from 0.85 to 1.1, more preferably from 0.9 to 1.05, even more preferably from 0.9 to 0.99.

### EXAMPLES

1) Measurement of the Non-Polymer Catechins

A sample solution was filtered by a filter (0.45 μm), and analyzed by a gradient method using a high-performance liquid chromatograph (type SCL-10AVP, manufactured by Shimadzu Corporation) equipped with an octadecyl group-introduced packed column for liquid chromatography L-column TM ODS (4.6 mmφ×250 mm: manufactured by Chemicals Evaluation and Research Institute, Japan) at a column temperature of 35° C. Measurement was carried out under the following conditions. A solution of 0.1 mol/L acetic acid in distilled water was used as a mobile phase solution A, a solution of 0.1 mol/L acetic acid in acetonitrile was used as a mobile phase solution B, the sample injection volume was 20 μL, and the UV detector wavelength was 280 nm.

2) Measurement of Tannin

Tannin was measured in terms of gallic acid by a ferrous tartrate method using ethyl gallate as a standard solution (reference: “Green tea polyphenol” Functional material effective utilization technology series for dietary drinks and foods, NO. 10). 5 mL of a sample was colored with 5 mL of a ferrous tartrate standard solution, and the total volume was adjusted to 25 mL with a phosphate buffer. An absorbance was measured at 540 nm, and the amount of tannin was determined based on a calibration curve of ethyl gallate.

Preparation of ferrous tartrate standard solution: 100 mg of ferrous sulfate heptahydrate and 500 mg of sodium potassium tartrate were dissolved in distilled water so that the total volume was 100 mL.

Preparation of phosphate buffer: A solution of 1/15 mol/L disodium hydrogen phosphate and a solution of 1/15 mol/L sodium dihydrogen phosphate were mixed, and a pH of the mixture was adjusted to 7.5.

3) Measurement of Potassium

Potassium was measured in accordance with “Interpretation of analysis manual of standard tables of food composition in Japan written by analysts, fifth edition” (edited by Japan Food Research Laboratories, Chuohoki Publishing CO., Ltd., published on Jul. 10, 2001), p. 90-91 and p. 99-103. Specifically, 2 to 5 g of a sample was weighed in an extraction container, and 200 mL of a solution of 1% hydrochloric acid were added, followed by extraction while shaking at room temperature for 30 minutes. The resulting extract solution was transferred to a centrifuge tube and centrifuged, and the resultant supernatant was used as a test solution for atomic absorption. Potassium was measured using an atomic absorption spectrometer at a measurement wavelength of 766.5 nm. Then, the amount of potassium in the sample was quantified using a calibration curve prepared in advance.

4) Measurement of Brix Degree

The Brix degree (sugar refractometer index) at 20° C. of a sample was measured using a saccharimeter (Atago RX-5000 (manufactured by Atago)).

5) Sensory Evaluation

The beer flavored beverages containing the non-polymer catechins obtained in Examples and Comparative Examples were subjected to a drinking test by a panel of five experts. The drinking test was carried out by evaluating the samples on bitterness, astringency, and refreshing finish peculiar to beer based on the following criteria, and then determining the final scores through discussion.

Evaluation Criteria of Bitterness

4: Having adequate bitterness

3: Having a slightly strong bitterness or slightly weak bitterness

2: Having a strong bitterness or weak bitterness

1: Having too strong of bitterness or too weak of bitterness

Evaluation Criteria of Astringency

4: Having little astringency

3: Having a weak astringency

2: Having a slight astringency

1: Having astringency

Evaluation Criteria of Refreshing Finish Peculiar to Beer

4: Having refreshing finish peculiar to beer

3: Having slight refreshing finish peculiar to beer

2: Having a little refreshing finish peculiar to beer

1: Having no refreshing finish peculiar to beer

### Production Example 1

Preparation of Purified Catechin Preparation

200 g of a concentrated green tea extract solution (POLYPHENON HG, manufactured by Mitsui Norin Co., Ltd.) was dispersed in 800 g of an aqueous solution of 95 mass % ethanol at 25° C. under a stirring condition of 250 r/min, and 100 g of acid clay (MIZUKA ACE #600, manufactured by MIZUSAWA INDUSTRIAL CHEMICALS, LTD.) was added thereto, followed by stirring for about 10 minutes. Subsequently, the mixture was filtered using #2 filter paper, and 16 g of activated carbon was added to the resulting filtrate, followed by filtration again using the #2 filter paper. Subsequently, the filtrate was filtered again using a 0.2-μm membrane filter. Subsequently, ethanol was distilled off from the filtrate at 40° C. under reduced pressure, and the concentration of the non-polymer catechins was adjusted with ion-exchange water, thereby obtaining a “green tea extract.” The purity of the non-polymer catechins in the solid content was 62.7 mass %. In the preparation, the concentration of the non-polymer catechins was 14.8 mass %, and the mass ratio of non-polymer catechins/tannin was 0.94.

Crude Catechin Preparation

POLYPHENON HG (manufactured by Mitsui Norin Co., Ltd.) was used as a crude catechin preparation. The purity of the non-polymer catechins in the solid content was 33 mass %, the concentration of the non-polymer catechins in the preparation was 33 mass %, and the mass ratio of non-polymer catechins/tannin was 0.85.

### Example 1

1.69 g of the purified catechin preparation and 15 g of a non-fermented malt extract (Malt Brown HQ, manufactured by San-Ei Gen F.F.I., Inc., Brix degree: 15) were dissolved in ion-exchanged water, and the pH of the mixture was adjusted to 3.8 with phosphoric acid to prepare a solution with a total weight of 240 g. The solution was poured in a pressure-proof PET bottle, and 260 g of carbonated water cooled to 5° C. was added thereto. A cap was put thereon, and the resultant was mixed to obtain a beer flavored beverage containing the non-polymer catechins having a pH of 3.8, a gas volume of 2.5, and a Brix degree of 2.7.

### Examples 2 to 12 and Comparative Examples 1 to 6

Beer flavored beverages containing the non-polymer catechins were obtained in the same manner as in Example 1 except that the components shown in Table 1 were blended at ratios shown in Table 1.

TABLE 1

| | | Examples | | | | | | | | | |
|---|---|---|---|---|---|---|---|---|---|---|---|
| | | 1 | 2 | 3 | 4 | 5 | 6 | 7 | 8 | 9 | 10 |
| Blend | Purified catechin | 1.69 | 3.37 | 6.74 | 10.1 | 6.74 | 6.74 | 1.69 | — | 3.37 | 6.74 |
| (g) | preparation | | | | | | | | | | |
| | Crude catechin | — | — | — | — | — | — | — | 3.02 | — | — |
| | preparation | | | | | | | | | | |
| | Malt extract (B) | 15 | 15 | 15 | 15 | 133.4 | 1.65 | 133.4 | 15 | 15 | 15 |
| | (Brix degree: 15)¹⁾ | | | | | | | | | | |
| | Phosphoric acid | * | * | * | * | * | * | * | * | * | * |
| | Ethanol (95 vol %) | 0 | 0 | 0 | 0 | 0 | 0 | 0 | 0 | 10.8 | 5.4 |
| | Carbonated water | 260 | 260 | 260 | 260 | 260 | 260 | 260 | 260 | 260 | 260 |
| | (gas volume 4.8) | | | | | | | | | | |
| | Ion-exchange water | Balance | Balance | Balance | Balance | Balance | Balance | Balance | Balance | Balance | Balance |
| | Total | 500 | 500 | 500 | 500 | 500 | 500 | 500 | 500 | 500 | 500 |
| Analysis | Amount of | 50 | 100 | 200 | 300 | 200 | 200 | 50 | 200 | 100 | 200 |
| value | non-polymer | | | | | | | | | | |
| | catechins (A) (×10⁻³ | | | | | | | | | | |
| | mass %) | | | | | | | | | | |
| | Amount of potassium | 5.9 | 5.9 | 5.9 | 5.9 | 52 | 0.6 | 52 | 5.9 | 5.9 | 5.9 |
| | (C) (×10⁻³ mass %) | | | | | | | | | | |
| | Mass ratio ((C)/(A)) | 0.118 | 0.059 | 0.030 | 0.020 | 0.26 | 0.003 | 1.04 | 0.030 | 0.059 | 0.030 |
| | (—) | | | | | | | | | | |
| | Mass ratio | 0.94 | 0.94 | 0.94 | 0.94 | 0.94 | 0.94 | 0.94 | 0.85 | 0.94 | 0.94 |
| | ((A)/tannin (E)) (—) | | | | | | | | | | |
| | Purity of | 62.7 | 62.7 | 62.7 | 62.7 | 62.7 | 62.7 | 62.7 | 33.0 | 62.7 | 62.7 |
| | non-polymer | | | | | | | | | | |
| | catechins in solid | | | | | | | | | | |
| | contents (mass %) | | | | | | | | | | |
| | Amount of alcohol (D) | 0 | 0 | 0 | 0 | 0 | 0 | 0 | 0 | 2 | 1 |
| | (ethanol) (mass %) | | | | | | | | | | |
| | pH (20° C.) | 3.8 | 3.8 | 3.8 | 3.8 | 3.8 | 3.8 | 3.8 | 3.8 | 3.8 | 3.8 |
| Sensory | Bitterness | 3 | 4 | 4 | 3 | 4 | 4 | 3 | 4 | 4 | 4 |
| evaluation | Astringency | 4 | 4 | 4 | 3 | 4 | 3 | 4 | 3 | 3 | 3 |
| | Refreshing finish | 4 | 4 | 4 | 4 | 3 | 4 | 3 | 4 | 4 | 4 |
| | peculiar to beer | | | | | | | | | | |

| | | Examples | | Comparative Examples | | | | | |
|---|---|---|---|---|---|---|---|---|---|
| | | 11 | 12 | 1 | 2 | 3 | 4 | 5 | 6 |
| Blend | Purified catechin | 1.69 | 8.42 | 6.74 | 6.74 | 3.37 | 6.74 | 0.68 | 0.68 |
| (g) | preparation | | | | | | | | |
| | Crude catechin | — | — | — | — | — | — | — | — |
| | preparation | | | | | | | | |
| | Malt extract (B) | 51 | 51 | 166.7 | 0.65 | 15 | 15 | 15 | 15 |
| | (Brix degree: 15)¹⁾ | | | | | | | | |
| | Phosphoric acid | * | * | * | * | * | * | * | * |
| | Ethanol (95 vol %) | 0 | 0 | 0 | 0 | 16.2 | 10.8 | 0 | 10.8 |
| | Carbonated water | 260 | 260 | 260 | 260 | 260 | 260 | 260 | 260 |
| | (gas volume 4.8) | | | | | | | | |
| | Ion-exchange water | Balance | Balance | Balance | Balance | Balance | Balance | Balance | Balance |
| | Total | 500 | 500 | 500 | 500 | 500 | 500 | 500 | 500 |
| Analysis | Amount of | 50 | 250 | 200 | 200 | 100 | 200 | 20 | 20 |
| value | non-polymer | | | | | | | | |
| | catechins (A) (×10⁻³ | | | | | | | | |
| | mass %) | | | | | | | | |
| | Amount of potassium | 20 | 20 | 65 | 0.3 | 5.9 | 5.9 | 5.9 | 5.9 |
| | (C) (×10⁻³ mass %) | | | | | | | | |
| | Mass ratio ((C)/(A)) | 0.40 | 0.080 | 0.325 | 0.0015 | 0.059 | 0.030 | 0.295 | 0.295 |
| | (—) | | | | | | | | |
| | Mass ratio | 0.94 | 0.94 | 0.94 | 0.94 | 0.94 | 0.94 | 0.94 | 0.94 |
| | ((A)/tannin (E)) (—) | | | | | | | | |
| | Purity of | 62.7 | 62.7 | 62.7 | 62.7 | 62.7 | 62.7 | 62.7 | 62.7 |
| | non-polymer | | | | | | | | |
| | catechins in solid | | | | | | | | |
| | contents (mass %) | | | | | | | | |
| | Amount of alcohol (D) | 0 | 0 | 0 | 0 | 3 | 2 | 0 | 2 |
| | (ethanol) (mass %) | | | | | | | | |
| | pH (20° C.) | 3.8 | 3.8 | 3.8 | 3.8 | 3.8 | 3.8 | 3.8 | 3.8 |
| Sensory | Bitterness | 3 | 4 | 4 | 4 | 4 | 4 | 1 | 1 |
| evaluation | Astringency | 4 | 4 | 4 | 1 | 2 | 2 | 4 | 4 |
| | Refreshing finish | 4 | 4 | 2 | 4 | 4 | 4 | 4 | 4 |
| | peculiar to beer | | | | | | | | |

*: Amount for achieving pH 3.8
¹⁾Malt Brown (manufactured by San-Ei Gen F.F.I., Inc.)

From Table 1, it was found that the beer flavored beverage containing the non-polymer catechins at a high concentration but having bitterness and refreshing finish suitable for the beverage to have a beer taste, and suppressed astringency incompatible with the beer taste and flavor, can be obtained by controlling the concentration of the non-polymer catechins (A), the concentration of the potassium (C), and the mass ratio there between to specific ranges in a beverage obtained by blending the non-polymer catechins (A) and the malt extract (B), and adjusting the quantitative ratio between the component (A) and the component (D) to satisfy the relationship.

1-12. (canceled)

13. A beer flavored beverage, comprising components (A), (B), (C), and (D):
(A) from 0.03 to 0.4 mass % of the non-polymer catechins;
(B) a malt extract;
(C) from 0.0005 to 0.06 mass % of potassium; and
(D) from 0 to 2.8 mass % of an alcohol,
wherein:
a mass ratio ((C)/(A)) between component (A) and component (C) ranges from 0.003 to 1.2; and
a quantitative ratio between component (A) and component (D) satisfies a relationship represented by expression (1):
0≦(d)≦3−6.5×(a) (1)
wherein (a) and (d) represent a mass fraction (mass %) of component (A) and a mass fraction (mass %) of component (D), respectively.

14. The beverage according to claim 13, wherein a content of component (A) ranges from 0.05 to 0.3 mass %.

15. The beverage according to claim 13, wherein a content of component (A) ranges from 0.06 to 0.25 mass %.

16. The beverage according to claim 13, wherein a content of component (C) ranges from 0.0006 to 0.052 mass %.

17. The beverage according to claim 13, wherein a content of component (C) ranges from 0.001 to 0.05 mass %.

18. The beverage according to claim 13, wherein the mass ratio ((C)/(A)) between component (A) and component (C) ranges from 0.01 to 0.7.

19. The beverage according to claim 13, wherein the mass ratio ((C)/(A)) between component (A) and component (C) ranges from 0.02 to 0.5.

20. The beverage according to claim 13, further comprising carbon dioxide gas (F).

21. The beverage according to claim 20, wherein a content of the carbon dioxide gas (F) ranges from 0.5 to 4 in terms of gas volume ratio.

22. The beverage according to claim 13, wherein component (B) is a non-fermented malt extract.

23. The beverage according to claim 13, wherein component (B) is a malt extract having a Brix degree of from 5 to 30.

24. The beverage according to claim 13, wherein a content of the potassium in component (B) ranges from 0.05 to 0.3 mass %.

25. The beverage according to claim 23, wherein a content of component (B) ranges from 0.2 to 30 mass %.

26. The beverage according to claim 13, wherein a content of the alcohol (D) ranges from 0 to 2.74 mass %.

27. The beverage according to claim 13, wherein a content of the alcohol (D) ranges from 0 to 2 mass %.

28. The beverage according to claim 13, wherein the beverage is a non-alcoholic beverage.

29. The beverage according to claim 28, wherein a content of the alcohol (D) ranges from 0 to less than 1 mass %.

30. The beverage according to claim 13, wherein the beverage has a pH of from 2 to 5.

31. The beverage according to claim 13, wherein a mass ratio ((A)/(E)) between component (A) and tannin (E) ranges from 0.8 to 1.2.

32. The beverage according to claim 13, wherein a Brix degree ranges from 0.1 to 10.

33. The beverage according to claim 24, wherein a content of component (B) ranges from 0.2 to 30 mass %.
